(19) United States
(12) Patent Application Publication
(10) Pub. No.: US 2024/0251718 A1
(43) Pub. Date: Aug. 1, 2024

(54) Floral Design Devices And Systems

(71) Applicant: Pickletown Creative LLC, Denver, CO (US)

(72) Inventors: Jessica J. Sparzak, Oak Ridge, TN (US); William M. Fischer, Golden, CO (US)

(21) Appl. No.: 18/414,492

(22) Filed: Jan. 17, 2024

Related U.S. Application Data
(60) Provisional application No. 63/482,572, filed on Jan. 31, 2023.

(51) Int. Cl. A01G 5/04; A01G 5/02

(52) U.S. Cl. CPC A01G 5/04; A01G 5/02

(57) ABSTRACT

Floral design devices and systems, and methods of manufacturing the same. A floral design device may include a grid having a plurality of grid openings. The floral design device may include an edge structure. The edge structure may be formed of one or more pieces. The grid may be disposed at least in part within a planar region defined by a perimeter of the one or more pieces of the edge structure. A floral design system may include a plurality of instances of the disclosed floral design device. A method of manufacturing a floral design device includes forming or providing an edge structure as one or more pieces; forming or providing a grid having a plurality of grid openings; and placing the grid at least in part within a planar region defined by a perimeter of the one or more pieces of the edge structure.

### CROSS-REFERENCE TO RELATED APPLICATIONS

This international patent application claims the benefit of and priority to U.S. Provisional Patent Application No. 63/482,572 filed on Jan. 31, 2023, which is incorporated herein by reference in its entirety.

### BACKGROUND

Floral wreaths and floral design crafts are a popular part of the craft and decor marketplace. Currently, floral designs and wreaths may be made for each season with the components being permanently affixed to a base. As a result, new bases may need to be repeatedly purchased and designed to suit a new style. In at least some cases, these products must then be stored for reuse. When purchasing these items from online retailers, the entire design with the base may have to be shipped. Shipping costs for a full-round wreath or design can be costly. As such, a need exists in the art for an option that can cut down on cost and increase creativity.

### SUMMARY

Described and illustrated herein are floral design devices and systems having useful features, and methods for manufacturing embodiments of the disclosed floral design devices and systems. The present technology advantageously changes the conventional approach to creating and enjoying floral wreaths and other products with more ease, less storage, no glue, and re-usability.

A first aspect of the disclosure provides a floral design device. The floral design device may include a grid having a plurality of grid openings. The floral design device may include an edge structure. The edge structure may be formed of one or more pieces. The grid may be disposed at least in part within a planar region defined by a perimeter of the one or more pieces of the edge structure.

In a first embodiment of the first aspect of the disclosure, each grid opening of the plurality of grid openings may have a substantially equal area. Alternatively, in the first embodiment, at least one grid opening of the plurality of grid openings may have a different area as compared to at least one other grid opening of the plurality of grid openings.

In a second embodiment of the first aspect of the disclosure, or in the first embodiment thereof, the grid may be arranged substantially along a plane defined by the edge structure (30). Alternatively, in the second embodiment, at least a portion of the grid may be arranged substantially along a plane defined by the edge structure, and at least another portion of the grid may be arranged out of the plane defined by the edge structure.

In a third embodiment of the first aspect of the disclosure, or in the first and/or second embodiment(s) thereof, at least a portion of the grid may be coupled to at least a portion of the edge structure. In the third embodiment, the at least a portion of the grid may be removably coupled to the at least a portion of the edge structure.

In a fourth embodiment of the first aspect of the disclosure, or in the first, second, and/or third embodiment(s) thereof, the edge structure may be formed of one piece. Alternatively, in the fourth embodiment, the one or more pieces of the edge structure may include at least two pieces including: at least one edge piece, and at least one cross piece coupled to the at least one edge piece. In the latter example of the fourth embodiment, the at least one cross piece may be removably coupled to the at least one edge piece.

In a fifth embodiment of the first aspect of the disclosure, or in the first, second, third and/or fourth embodiment(s) thereof, the floral design device may include at least one extension piece coupled to the edge structure. In an example of the fifth embodiment, the at least one extension piece may be configured to facilitate binding at least a portion of the edge structure to another object (e.g., to another floral design device according to the first aspect according to the first aspect of the disclosure). In another example of the fifth embodiment, the at least one extension piece may be configured to receive, or couple to, means for binding the at least a portion of the edge structure to the another object. In yet another example of the fifth embodiment, the floral design device may further include a plurality of extension pieces coupled to different portions of the edge structure.

In a sixth embodiment of the first aspect of the disclosure, or in the first, second, third, fourth and/or fifth embodiment(s) thereof, the floral design device may include means for binding at least a portion of the grid to the another object. In a seventh embodiment of the first aspect of the disclosure, or in first, second, third, fourth, fifth and/or sixth embodiment(s) thereof, the floral design device may include means for binding at least a portion of the edge structure to the another object.

In an eighth embodiment of the first aspect of the disclosure, or in first, second, third, fourth, fifth, sixth and/or seventh embodiment(s) thereof, the perimeter of the one or more pieces of the edge structure may defines a shape of the floral design device. In an example of the eighth embodiment, the shape defined by the perimeter may be a polygon. In another example of the eighth embodiment, the shape defined by the perimeter may have at least one partially arcuate side. In yet another example of the eighth embodiment, the shape may have at least two partially arcuate sides. In still another example of the eighth embodiment, the shape defined by the perimeter may be at least partially circular. In yet another example of the eighth embodiment, the shape may be at at least partially ovoid. In still another example of the eighth embodiment, the shape defined by the perimeter may be pie shaped. In yet another example of the eighth embodiment, the shape defined by the perimeter may be C-shaped. In still another example of the eighth embodiment, the shape defined by the perimeter may be S-shaped. In yet another example of the eighth embodiment, the shape defined by the perimeter may be U-shaped. In still another example of the eighth embodiment, the shape defined by the perimeter may be W-shaped. In yet another example of the eighth embodiment, the shape defined by the perimeter may be wave shaped.

A second aspect of the disclosure provides a floral design system. The floral design system may include a plurality of instances of the floral design device according to the first aspect of the disclosure. In a first embodiment of the second aspect of the disclosure, the plurality of instances of the floral design device may be coupled or bound together. In a second embodiment of the second aspect of the disclosure, or in the first embodiment thereof, two or more of the plurality of instances of the floral design device may be coupled or bound together between a portion of the edge structure of a first floral design device and a portion of the edge structure of at least a second floral design device. In a third embodiment of the second aspect of the disclosure, or in the first and/or second embodiment thereof, the two or more of the plurality of instances of the floral design device may be removably or detachably coupled or bound together.

A third aspect of the disclosure provides a method of manufacturing a floral design device. The method may include the step of forming or providing an edge structure as one or more pieces. The method may include the step of forming or providing a grid having a plurality of grid openings. The method may include the step of placing the grid at least in part within a planar region defined by a perimeter of the one or more pieces of the edge structure.

In a first embodiment of the third aspect of the disclosure, the method step of forming the grid may include forming the grid having each grid opening of the plurality of grid openings having a substantially equal area. Alternatively, in the first embodiment, the method step of forming the grid may include forming the grid having at least one grid opening of the plurality of grid openings having a different area as compared to at least one other grid opening of the plurality of grid openings. In an example of the first embodiment, the method step of forming the grid may include the method step of providing the grid (e.g., prior to, or concurrent with, forming the edge structure in the method).

In a second embodiment of the third aspect of the disclosure, or in the first embodiment thereof, the method step of providing the grid may include providing the grid having each grid opening of the plurality of grid openings having a substantially equal area. Alternatively, in the second embodiment, the method step of providing the grid may include providing the grid having at least one grid opening of the plurality of grid openings having a different area as compared to at least one other grid opening of the plurality of grid openings. In an example of the second embodiment, the method step of providing the grid may include the method step of forming the grid (e.g., prior to, or concurrent with, providing the edge structure in the method).

In a third embodiment of the third aspect of the disclosure, or in the first and/or second embodiment(s) thereof, the method step of placing the grid may include arranging the grid substantially along a plane defined by the edge structure. Alternatively, in the third embodiment, the method step of placing the grid may include: arranging at least a portion of the grid substantially along a plane defined by the edge structure, and arranging at least another portion of the grid out of the plane defined by the edge structure.

In a fourth embodiment of the third aspect of the disclosure, or in the first, second and/or third embodiment(s) thereof, the method step of placing the grid may include coupling at least a portion of the grid to at least a portion of the edge structure. In an example of the fourth embodiment, the method step of coupling at least a portion of the grid may include removably coupling the at least a portion of the grid to the at least a portion of the edge structure.

In a fifth embodiment of the third aspect of the disclosure, or in the first, second, third and/or fourth embodiment(s) thereof, the method step of forming the edge structure may include forming the edge structure as one piece. Alternatively, in the fifth embodiment, the method step of forming the edge structure may include forming the edge structure as at least two pieces including: at least one edge piece, and at least one cross piece coupled to the at least one edge piece. In an example of the fifth embodiment, the method may include the step of removably coupling the at least one cross piece to the at least one edge piece. In another example of the fifth embodiment, the method step of forming the edge structure may include the method step of providing the edge structure (e.g., prior to, or concurrent with, forming the edge structure in the method).

In a sixth embodiment of the third aspect of the disclosure, or in the first, second, third, fourth and/or fifth embodiment(s) thereof, the method step of providing the edge structure may include providing the edge structure as one piece. Alternatively, in the sixth embodiment, the method step of providing the edge structure may include providing the edge structure as at least two pieces including: at least one edge piece, and at least one cross piece coupled to the at least one edge piece. In an example of the sixth embodiment, the method may include the step of removably coupling the at least one cross piece to the at least one edge piece. In another example of the sixth embodiment, the method step of providing the edge structure may include the method step of forming the edge structure (e.g., prior to, or concurrent with, providing the edge structure in the method).

In a seventh embodiment of the third aspect of the disclosure, or in the first, second, third, fourth, fifth and/or sixth embodiment(s) thereof, the method may include the step of coupling at least one extension piece to the edge structure. In an example of the seventh embodiment, the method step of coupling the at least one extension piece to the edge structure may facilitates binding at least a portion of the edge structure to another object during operation of the floral design device by a user thereof. The another object may be another floral design device. In that case of the seventh embodiment, the step of coupling the at least one extension piece to the edge structure may further facilitate binding the at least a portion of the edge structure to the another floral design device during operation of the floral design device by the user.

In an eighth embodiment of the third aspect of the disclosure, or in the first, second, third, fourth, fifth, sixth and/or seventh embodiment(s) thereof, the method may include the step of receiving means for binding the at least a portion of the edge structure to the another object into, onto, or to the at least one extension piece. In an example of the eighth embodiment, the method step of receiving the means for binding may include the method step of coupling the means for binding the at least a portion of the edge structure to the another object into, onto, or to the at least one extension piece (e.g., prior to, after, or concurrent with, receiving the means for binding the at least a portion of the edge structure to the another object into, onto, or to the at least one extension piece in the method).

In a ninth embodiment of the third aspect of the disclosure, or in the first, second, third, fourth, fifth, sixth, seventh and/or eighth embodiment(s) thereof, the method may include the step of coupling means for binding the at least a portion of the edge structure to the another object into, onto, or to the at least one extension piece. In an example of the ninth embodiment, the method step of coupling the means for binding may include the method step of receiving the means for binding the at least a portion of the edge structure to the another object into, onto, or to the at least one extension piece (e.g., prior to, after, or concurrent with, coupling the means for binding the at least a portion of the edge structure to the another object into, onto, or to the at least one extension piece in the method).

In a tenth embodiment of the third aspect of the disclosure, or in the first, second, third, fourth, fifth, sixth, seventh, eighth and/or ninth embodiment(s) thereof, the method may include the step of coupling a plurality of extension pieces to different portions of the edge structure. In an eleventh embodiment of the third aspect of the disclosure, or in the first, second, third, fourth, fifth, sixth, seventh, eighth, ninth and/or tenth embodiment(s) thereof, the method may include the step of coupling, forming and/or providing means for binding at least a portion of the grid to another object to, on, in, or onto at least a portion of the grid. In a twelfth embodiment of the third aspect of the disclosure, or in the first, second, third, fourth, fifth, sixth, seventh, eighth, ninth, tenth and/or eleventh embodiment(s) thereof, the method may include the step of coupling, forming and/or providing means for binding at least a portion of the edge structure to the another object to, on, in, or onto at least a portion of the edge structure.

In a thirteenth of the third aspect of the disclosure, or in the first, second, third, fourth, fifth, sixth, seventh, eighth, ninth, tenth, eleventh and/or twelfth embodiment(s) thereof, the method step(s) of forming and/or providing the edge structure may include forming and/or providing the edge structure having the perimeter defining a shape of the floral design device. In an example of the thirteenth embodiment, the shape defined by the perimeter may be a polygon. In another example of the thirteenth embodiment, the shape defined by the perimeter may have at least one partially arcuate side. In yet another example of the thirteenth embodiment, the shape defined by the perimeter may have at least two partially arcuate sides. In still another example of the thirteenth embodiment, the shape defined by the perimeter may be at least partially circular. In yet another example of the thirteenth embodiment, the shape defined by the perimeter may be at at least partially ovoid. In still another example of the thirteenth embodiment, the shape defined by the perimeter may be pie shaped. In yet another example of the thirteenth embodiment, the shape defined by the perimeter may be C-shaped. In still another example of the thirteenth embodiment, the shape defined by the perimeter may be S-shaped. In yet another example of the thirteenth embodiment, the shape defined by the perimeter may be U-shaped. In still another example of the thirteenth embodiment, the shape defined by the perimeter may be W-shaped. In yet another example of the thirteenth embodiment, the shape defined by the perimeter may be wave shaped.

In a fourteenth embodiment of the third aspect of the disclosure, or in the first, second, third, fourth, fifth, sixth, seventh, eighth, ninth, tenth, eleventh, twelfth and/or thirteenth embodiment(s) thereof, the method may include the step of coupling together a plurality of instances of the floral design device to manufacture, or otherwise form or create, a floral design system (e.g., the system according to the second aspect of the disclosure). In a fifteenth embodiment of the third aspect of the disclosure, or in the first, second, third, fourth, fifth, sixth, seventh, eighth, ninth, tenth, eleventh, twelfth, thirteenth and/or fourteenth embodiment(s) thereof, the method step of coupling together a plurality of instances of the floral design device may include coupling a portion of the edge structure of a first floral design device to a portion of the edge structure of at least a second floral design device.

### BRIEF DESCRIPTION OF THE DRAWINGS

The appended figures provide views of floral design devices and systems, and methods of manufacturing the same, according to some embodiments of the present disclosure. Notably, the floral design devices and systems depicted in the appended drawings are not intended to be necessarily drawn to scale. Furthermore, the examples shown in the drawings are only examples of some embodiments of the disclosure, and it is strongly emphasized that features such as shapes, dimensions, and positioning of certain features relative to other features may be varied without departing from the scope and spirit of this disclosure.

FIG. 1 is a diagram of a floral design device according to some embodiments.

FIG. 2 depicts a view of a floral design device with florals according to some embodiments.

FIG. 3 depicts another view of a floral design device with florals according to some embodiments.

FIG. 4 is another diagram of a floral design device with extensions according to some embodiments.

FIG. 5 is yet another diagram of a floral design device with extensions according to some embodiments.

FIG. 6 is still another diagram of a floral design device with extensions according to some embodiments.

FIG. 7 is another diagram of a floral design device with extensions according to some embodiments.

FIG. 8 is yet another diagram of a floral design device with extensions according to some embodiments.

FIG. 9 is still another diagram of a floral design device with extensions according to some embodiments.

FIGS. 10A-10D depict diagrams of floral design devices according to some embodiments.

FIG. 11 is a perspective, and partially exploded, view of a floral design device according to some embodiments.

FIG. 12 is a flowchart of a method of manufacturing a floral design device according to some embodiments.

### DETAILED DESCRIPTION

The following description is made with reference to the appended figures. Features mentioned below and attached to numbers correspond to those numbered features of the figures. Some features may be described below without numbers and corresponding labels in the drawings. In some such instances, a person having ordinary skill in the art may be expected to readily envision such features and how they may be implemented in the floral design devices and systems, and associated methods, according to the present disclosure without requiring undue experimentation. Furthermore, a person having ordinary skill in the art may be expected to add features to the described embodiments and/or to vary arrangements, steps, sizes, shapes, types, materials, etc. and/or to recombine features from among the various embodiments described herein without departing from the scope and spirit of the disclosed floral design devices and systems, and associated methods.

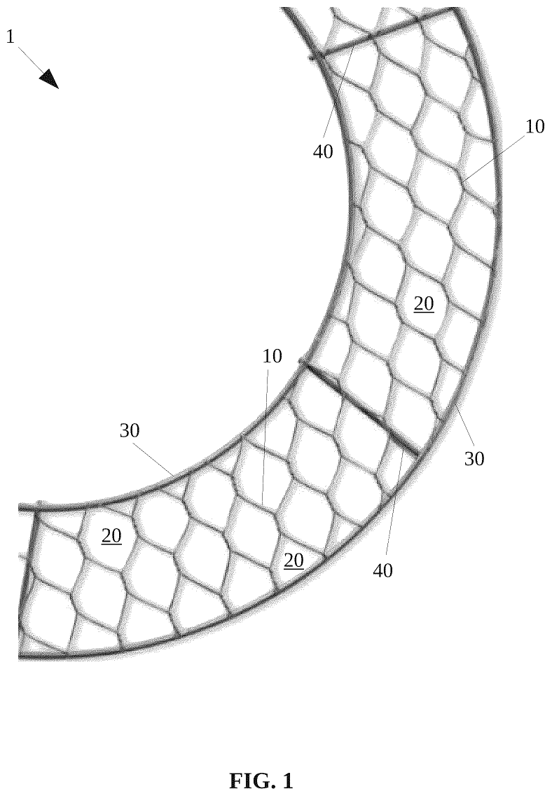

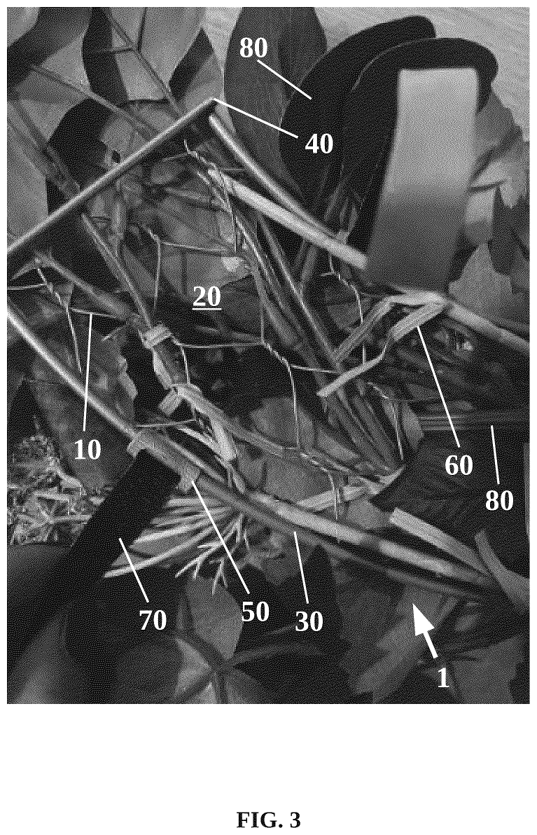

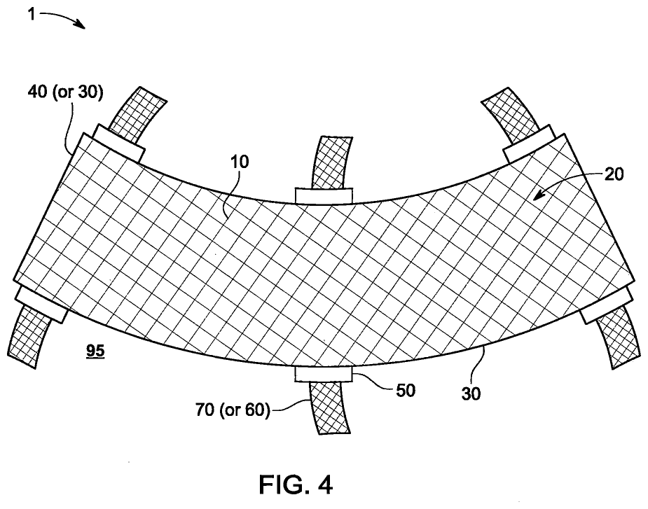

FIGS. 1-9 are diagrams of a floral design device (1) according to several embodiments. Floral design device (1) may include a grid (10) having a plurality of grid openings (20). Floral design device (1) may include an edge structure (30) formed of one or more pieces (30 and/or 40). The grid (10) may be disposed at least in part within a planar region defined by a perimeter of the one or more pieces (30, 40) of the edge structure (30).

The various structural components of the embodiments of the floral design device (1) described herein may be made (e.g., formed) of a variety of materials. Weight, durability, hardness, and flexibility of materials may be considerations at play in the selection of materials for use in the disclosed floral design device (1). Such materials may include, for example and without limitation, plastic, fiber, clay, metal, wood, foam, and glass, and combinations thereof.

The component parts of the disclosed floral design device (1) may be fabricated using a variety of techniques. Such techniques may include, for example and without limitation, molding, cutting, carving, extruding, and additive manufacturing, and combinations thereof. In some embodiments, the floral design device (1) as a whole, or one or more of its component parts, may be formed as a one piece (e.g., continuous) structure. In other embodiments, the floral design device (1) as a whole, or one or more of its component parts, may be formed as multiple pieces that are permanently or removably attached (e.g., “coupled”) together in any of several ways, as for example and without limitation, snap fits, screws, nails, adhesives, knots, bolts, braids, splices, ties, welds, and interlocking connections between parts, and combinations thereof. These, and other attachment (coupling) structures and associated techniques may be more generally referred to herein as “fastener(s),” “fastening” and/or “means for binding.”

As shown, for example, in FIGS. 1-3, grid (10) may be formed of a wire grid similar to “chicken wire,” where the area and shape of grid openings (20) are dictated by the spacing between the positions that wires are twisted together. In this case, the wires of grid (10) may be coated in plastic, rubber or paint. In these example embodiments, the shape of each grid opening (20) of the plurality of grid openings (20) of grid (10) may be substantially the same over the entirety of grid (10).

As used herein, the term “substantially” means that the physical property that is referred to (e.g., shape, area, and the like) does not vary in a noticeable or meaningful way so as to introduce some different functionality that is related to the particular physical property. For instance, if a physical property like an area of one grid opening (20) as compared to another grid opening (20) of the grid (10)—where those two area values are of planar regions defined by the respective grid openings (20)—does not differ by more than 20%, then those areas may be said to be substantially equal. In some cases, “substantially” may instead mean that values or attributes of two or more physical properties do not vary (e.g., on average) by more than 10%, by more than 5%, by more than 1%, by more than 0.1%, or by more than 0.01%.

In other embodiments, the grid (10) may be formed in a one piece construction and of plastic or metal, rather than the chicken-wire type construction. In still other embodiments, grid (10) may be made from fiber. In the embodiments shown, for example, in FIGS. 1-9, the shape of each grid opening (20) of the plurality of grid openings (20) in grid (10) may be substantially diamond shaped. In other embodiments, the shape of each grid opening (20) of the plurality of grid openings (20) in grid (10) may be square or rectangle shaped. In still other embodiments, at least one grid opening (20) of the plurality of grid openings (20) may have a different shape as compared to at least one other grid opening (20) in grid (10).

In some embodiments, each grid opening (20) of the plurality of grid openings (20) has a substantially equal area (e.g., as shown in FIGS. 1-3). In other embodiments, at least one grid opening (20) of the plurality of grid openings (20) has a different area as compared to at least one other grid opening (20) of the plurality of grid openings (20).

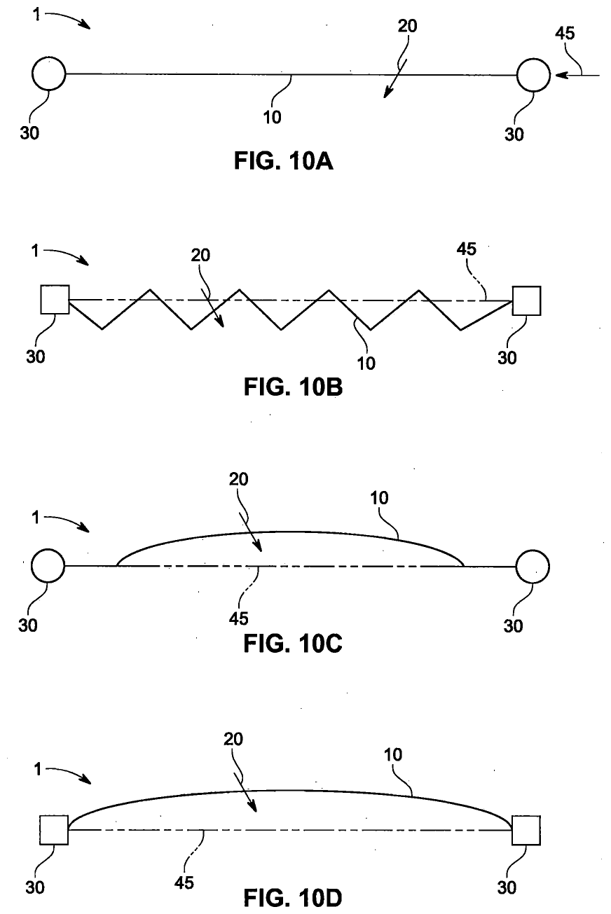

FIGS. 1-9 show top (e.g., plan) views of various embodiments of the floral design device (1), where a bottom view of the same may be substantially equivalent by symmetry. FIGS. 10A-10D show side (e.g., elevation) sectional views of various embodiments of the floral design device (1). Referring now to FIG. 10A, in some embodiments, grid (10) may be arranged substantially along a plane (45) defined by the edge structure (30). In this case, the entirety of grid (10) may, at least on average, lie substantially flat as disposed at least in part within a planar region (e.g., including plane (45)) defined by a perimeter of the one or more pieces (30, 40) of the edge structure (30).

Referring now to FIGS. 10B-10D, in some embodiments, at least a portion of the grid (10) may be arranged substantially along a plane (45) defined by the edge structure (30), and at least another portion of the grid (10) may be arranged out of the plane (45) defined by the edge structure (30). In such cases, the entirety of grid (10) may not lie substantially flat as disposed at least in part within a planar region defined by the perimeter of the one or more pieces (30, 40) of the edge structure (30).

As one example, illustrated in FIG. 10B, grid (10) may continually vary in elevation above and/or below a line denoting the plane (45) defined by edge structure (30). For instance, grid (10) may be take on a “zig zag” configuration when viewed from the side of device (1), as shown in FIG. 10B. As another example, illustrated in FIG. 10C, a portion of grid (10) may rise above (or below) the aforementioned plane (45) in an arcuate (or similarly polygonal, e.g., trapezoidal) fashion, while other portions of grid (10) (e.g., portion(s) of grid (10) proximate to edge structure (30)) may lie in the plane (45). As yet another example, illustrated in FIG. 10D, grid (10) may fully rise above (or below) the aforementioned plane (45) in an arcuate (or similarly polygonal, e.g., trapezoidal) fashion. In the case of the arcuate grid (10) shown in FIG. 10D, the elevation of grid (10) above (or below) plane (45) may vary continually. In the case of, for instance, the aforementioned trapezoidal case for grid (10), portion(s) of grid (10) may vary continually (e.g., slanted sides of the trapezoid), while other portion(s) of grid (10) (e.g., horizontal or non-slanting sides of the trapezoid) may have substantially constant elevation above (or below) plane (45).

Depending on a specific application of device (1) for the benefit of a floral designer or other user, configurations of grid (10) such as those described above with reference to FIGS. 10B-10D, for example and without limitation, may facilitate arranging and/or securing stems 80 and/or leaves 90 of florals onto grid (10) in a desired aesthetically pleasing manner.

In some embodiments, at least a portion of edge structure (30) may have a circular or ovoid, or other at least partially arcuate cross-sectional shape, as shown in FIGS. 10A and 10C. In other embodiments, at least a portion of edge structure (30) may have a square, rectangular or other polygonal cross-sectional shape, as shown in FIGS. 10B and 10D.

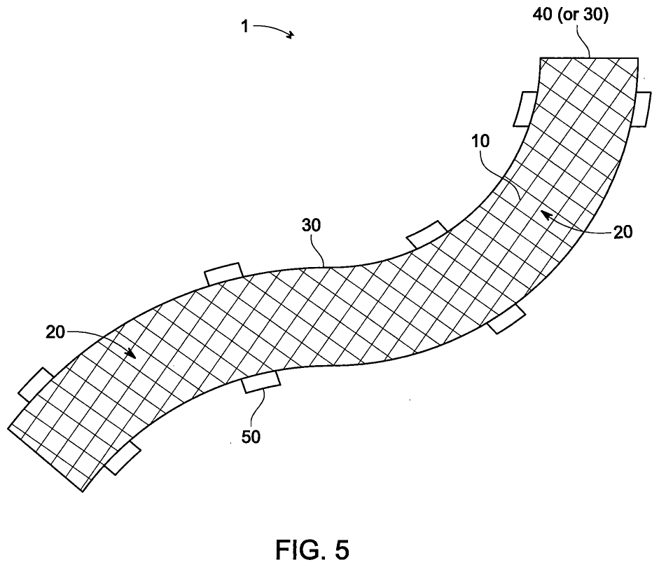

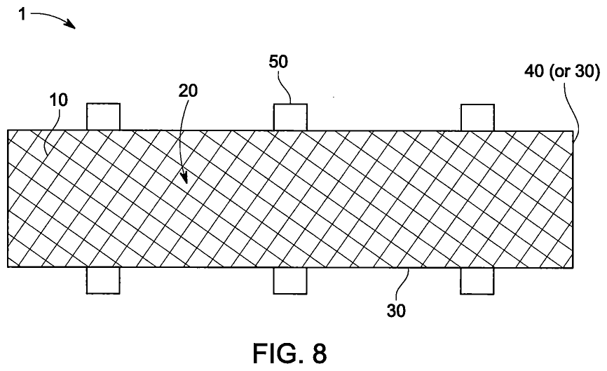

In some embodiments, at least a portion of the grid (10) may be coupled to at least a portion of the edge structure (30). In an example, at least a portion of the grid (10) may be removably coupled to at least a portion of the edge structure (30). In another example, edge structure (30) and/or grid (10) may be formed of a flexible material of construction, and a coupling between grid (10) and edge structure (30) may be a sliding and/or flexing coupling. In such a case, a floral design device (1) may be manipulated by a user thereof into differing shapes. In an example, a change of shape may be maintained following such manual manipulation force being withdrawn. So, for instance, a floral design device (1) having a substantially rectangular shape in a plan view (e.g., as shown in FIG. 8) may be manipulated into an arcuate shape (e.g., as shown in FIGS. 1-4) or into a wavy shape (e.g., as shown in FIG. 5). The embodiment shown in FIG. 5 may be especially suited for use with arches or mailboxes.

In some embodiments, the edge structure (30) may be formed of one piece (30). In other embodiments, the one or more pieces (30, 40) of the edge structure (30) may include at least two pieces (30, 40). These at least two pieces (30, 40) may include: at least one edge piece (30), and at least one cross piece (40) coupled to the at least one edge piece (30), as shown for example and without limitation, in FIG. 1. In an example, the at least one cross piece (40) may be removably coupled to the at least one edge piece (30).

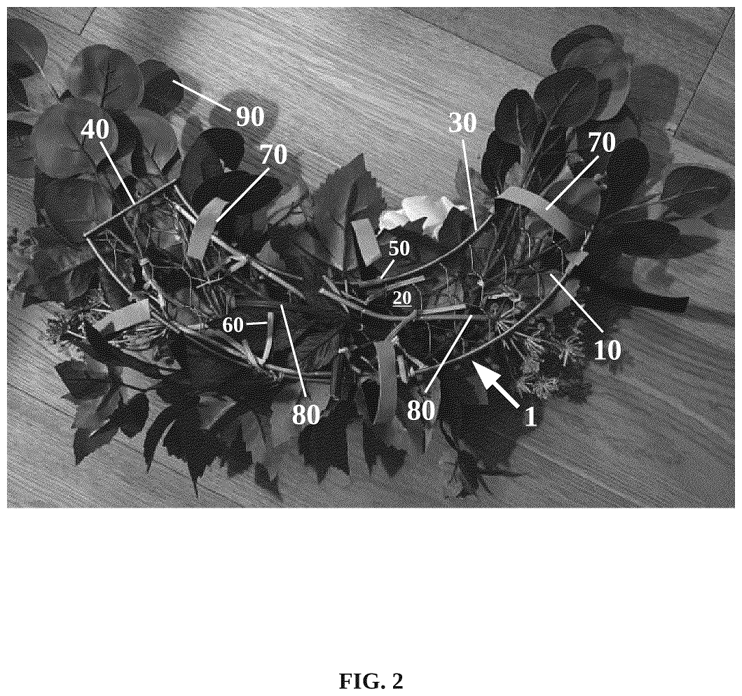

Referring now to FIGS. 2-9, in some embodiments, floral design device (1) may include at least one extension piece (50) coupled to the edge structure (30). The at least one extension piece (50) may facilitate a device (1) user's binding at least a portion of the edge structure (30) to another object (95). In an example, the another object (95) may be a base or a surface onto which the floral design device (1) is to be permanently or temporarily secured. For example, and without limitation, the extension piece(s) (50) may enable connecting the disclosed device (1) to a grapevine wreath base. In another example, the another object (95) may be one or more other (e.g., additional) floral design device(s) (1). In yet another example, the another object (95) may be a stem (80) and/or a leaf (90) of a natural or artificial floral or other plant, or plant-like, material.

In some embodiments, floral design device (1) may include a plurality of extension pieces (50) coupled to different portions of the edge structure (30). Device (1) may include means for binding at least a portion of the edge structure (30) to the another object (95). Each extension piece (50) of device (1) may be capable of receiving, or being coupled to, means for binding at least a portion of the edge structure (30) to the another object (95). The disclosed floral design device (1) may include means for binding at least a portion of the grid (10) to another object (95). In addition to, or instead of, fasteners generally described above, means for binding may include structures shown in FIGS. 2, 3 and 4. For example, and without limitation, at least one “twisty tie” (60) may be used to secure a stem 60 to edge structure (30) and/or grid (10), and a hook-and-loop fastener (70) (e.g., VELCRO) may be used to secure edge structure (30) (e.g., at extension piece (50)) to a base or other surface (95). Twisty ties (60) and hook-and-loop fasteners (70) may be desirable to users during operation of floral design device (1) because they may be reusable to enable repeated and alternate attachment and removal of pieces to/from one another and/or to/from other objects (95).

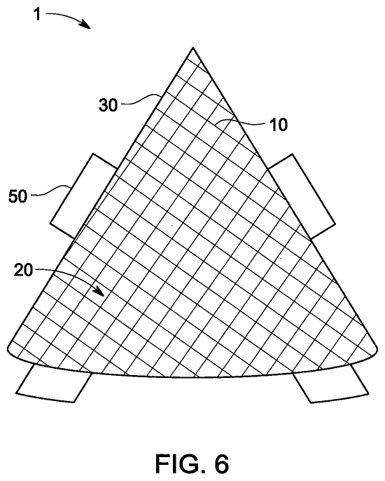

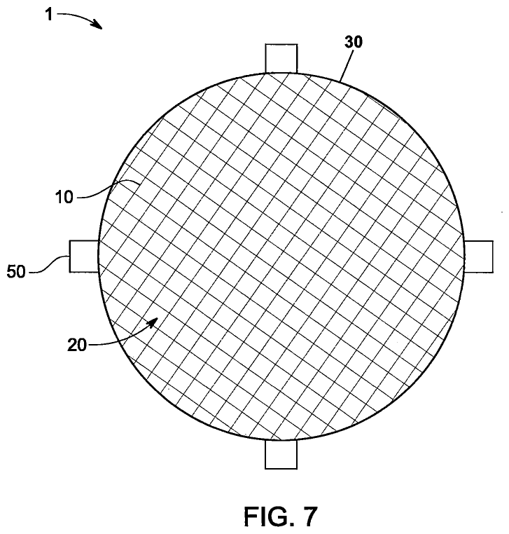

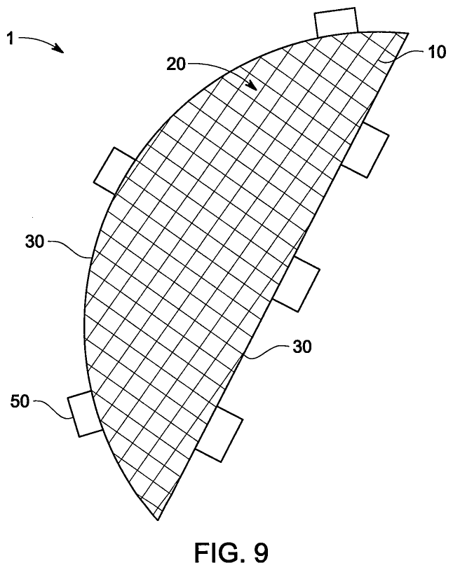

The perimeter of the one or more pieces (30, 40) of the edge structure (30) may define a shape of the disclosed floral design device (1). In an example, the shape may be a polygon (e.g., as shown in FIG. 8). In another example, the shape may have at least one partially arcuate side (e.g., as shown in FIGS. 6 and 9). In yet another example, the shape may have at least two partially arcuate sides (e.g., as shown in FIGS. 1-5). In still another embodiment, the shape may be at least partially circular or at least partially ovoid (e.g., as shown in FIG. 7). In another embodiment, the shape may be pie shaped (e.g., as shown in FIG. 6).

In some embodiments, the aforementioned perimeter defining plane (45) may include two edge pieces (30) and two cross pieces (40). In an example, a device (1) having this structural configuration may then be considered as one instance of the disclosed floral design device (1). Two or more instances of any of the embodiments of the disclosed floral design device (1) may be coupled together to thereby form a floral design system. In such a floral design system, instances of floral design device (1) may be coupled together between a portion of the edge structure (30) of a first floral design device (1) and a portion of the edge structure (30) of at least a second floral design device (1). In an example, the embodiment illustrated in FIG. 1 may be considered as a plurality of instances of floral design device (1) coupled together into a floral design system. In that case, each instance of floral design device (1) may have two edge pieces (30) and two cross pieces (40), where a cross piece (40) of a first device (1) may be coupled to a cross piece (40) of a second device (1), and so on and so forth for a desired number of instances of floral design device (1).

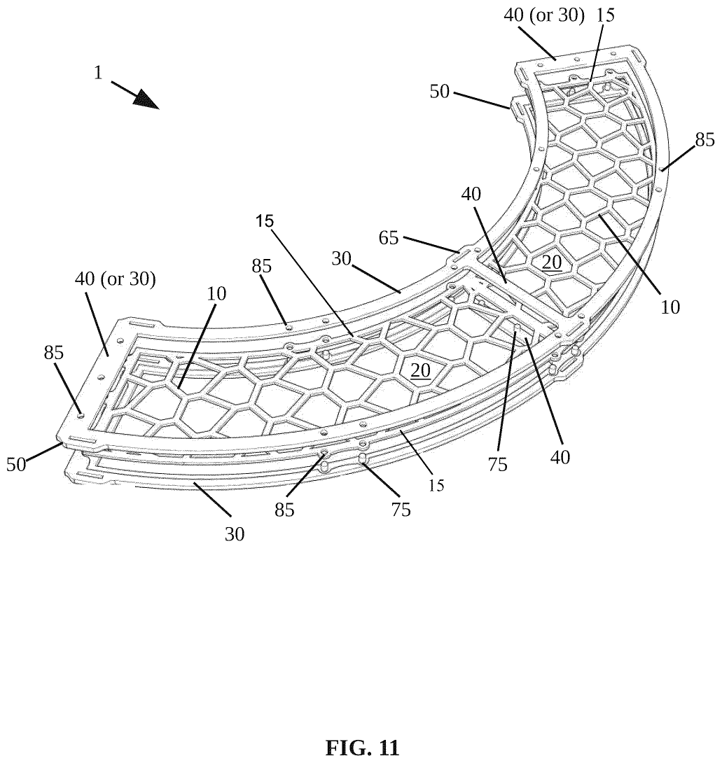

FIG. 11 is a perspective, and partially exploded, view of a floral design device according to some embodiments. In some embodiments, as shown in FIG. 11, grid (10) may include a grid border (15) that fits between two (or two sets) of edge pieces (30). In the illustrated example of FIG. 11, each of the two edge pieces (30) may include at least one cross piece (40). Each edge piece (30) may include one or more extension piece(s) (50). The extension piece(s) (50) may include respective slot(s) (65) for receiving, or being coupled to, means for binding at least a portion of the edge structure (30) to the another object (95), as described above. Portions of the grid (10), e.g., at portions of the grid border (15) thereof, may fit between the two edge pieces (30) by way of mating pegs (75) and holes (85), as shown in FIG. 11. In operation, in some embodiments, the pegs (75) and holes (85) may enable a snap fit assembly for the floral design device (1), where such a snap fit assembly may be alternately assembled and disassembled by a user as needed to change and/or modify any given design.

For reasons that are expected to be readily appreciable by persons having ordinary skill in the art, the various features of the disclosed floral design device (1) as described above with reference to FIGS. 1-9 and 10A-10D thus advantageously make it simple to change designs on a given base or surface.

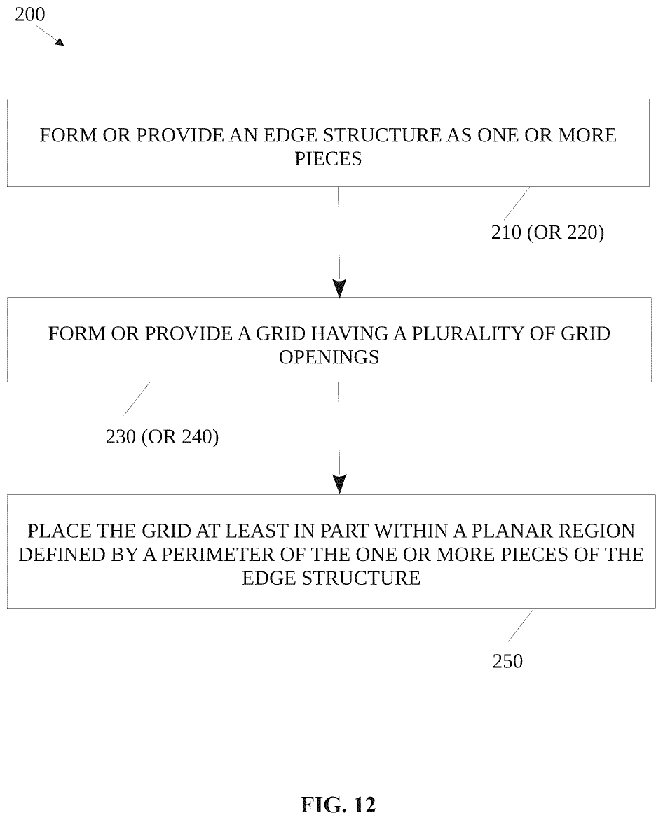

FIG. 12 is a flowchart of a method (200) of manufacturing a floral design device (1) according to some embodiments. The method (200) may include the step of forming (210) or providing (220) an edge structure (30) as one or more pieces (30, 40). The method (200) may include the step of forming (230) or providing (240) a grid (10) having a plurality of grid openings (20). The method (200) may include the step of placing (250) the grid (10) at least in part within a planar region defined by a perimeter of the one or more pieces (30, 40) of the edge structure (30).

In one embodiment, the method (200) step of forming (210) or providing (220) the edge structure (30) may include forming or providing the edge structure (30) as one piece (30). In other embodiments, the method (200) step of forming (210) or providing (220) the edge structure (30) may include forming or providing the edge structure (30) as at least two pieces (30, 40), where the at least two pieces (30, 40) may include: at least one edge piece (30), and at least one cross piece (40) coupled to the at least one edge piece (30). In an example, method (200) may include the step of removably coupling the at least one cross piece (40) to the at least one edge piece (30).

In some embodiments, the method (200) step of forming (210) or providing (220) the edge structure (30) may include forming or providing the edge structure having the perimeter defining a shape of the floral design device (1). In an example, the shape defined by the perimeter is a polygon (e.g., FIG. 8). In another example, the shape defined by the perimeter has at least one partially arcuate side (e.g., FIG. 8). In yet another example, the shape defined by the perimeter has at least two partially arcuate sides (e.g., FIG. 1). In still another example, the shape defined by the perimeter is at least partially circular or at least partially ovoid (e.g., FIG. 7). In yet another example, the shape defined by the perimeter is pie shaped (e.g., FIG. 6).

In one embodiment, the method (200) step of forming (230) or providing (240) the grid (10) may include forming or providing the grid having each grid opening (20) of the plurality of grid openings (20) having a substantially equal area. In another embodiment, the method (200) step of forming (230) or providing (240) the grid (10) may include forming or providing the grid having at least one grid opening (20) of the plurality of grid openings (20) having a different area as compared to at least one other grid opening (20) of the plurality of grid openings (20).

In one embodiment, the method (200) step of placing (250) the grid (10) may include arranging the grid (10) substantially along a plane (45) defined by the edge structure (30), as shown, for example, in FIG. 10A. In another embodiment, the method (200) step of placing (250) the grid (10) may include: arranging at least a portion of the grid (10) substantially along the plane (45) defined by the perimeter edge structure (30); and arranging at least another portion of the grid (10) out of the aforementioned plane (45), as shown, for example, in FIGS. 10B-10D.

In some embodiments, the method (200) step of placing (250) the grid (10) may include coupling at least a portion of the grid (10) to at least a portion of the edge structure (30). In an example, coupling at least a portion of the grid (10) may include removably coupling the at least a portion of the grid (10) to the at least a portion of the edge structure (30).

In some embodiments, method (200) may further include the step of coupling at least one extension piece (50) to the edge structure (30). In an example, coupling the at least one extension piece (50) to the edge structure (30) may facilitate binding at least a portion of the edge structure (30) to another object (95) during operation of the floral design device (1). The another object (95) may be embodied in another floral design device (1). In such cases, coupling the at least one extension piece (50) to the edge structure (30) may further facilitate binding at least a portion of the edge structure (30) to the another floral design device (1) during operation of the floral design device (1).

In some embodiments, method (200) may also include the step of receiving or coupling means for binding (e.g., 60 and/or 70) the at least a portion of the edge structure (30) to the another object (95) into, onto, or to the at least one extension piece (50). In one embodiment, method (200) may further include the step of coupling a plurality of extension pieces (50) to different portions of the edge structure (30). In some embodiments, method (200) may also include the step of coupling, forming or providing means for binding (e.g., 60 and/or 70) at least a portion of the grid (10) to another object (95) to, on, in, or onto at least a portion of the grid (10). In one embodiment, method (200) may further include the step of coupling, forming or providing means for binding (e.g., 60 and/or 70) at least a portion of the edge structure (30) to another object (95) to, on, in, or onto at least a portion of the edge structure (30).

In some embodiments, method (200) may also include the step of coupling together a plurality of instances of the floral design device (1) to further manufacture a floral design system. In an example, the method (200) step of coupling together a plurality of instances of the floral design device (1) may include coupling a portion of the edge structure (30) of a first floral design device (1) to a portion of the edge structure (30) of at least a second floral design device (1).

1. A floral design device comprising:
a grid having a plurality of grid openings; and
an edge structure formed of one or more pieces,
wherein the grid is disposed at least in part within a planar region defined by a perimeter of the one or more pieces of the edge structure.

2. The floral design device of claim 1, wherein one of:
each grid opening of the plurality of grid openings has a substantially equal area; and
at least one grid opening of the plurality of grid openings has a different area as compared to at least one other grid opening of the plurality of grid openings.

3. The floral design device of claim 1, wherein the grid is arranged substantially along a plane defined by the edge structure.

4. The floral design device of claim 1, wherein at least a portion of the grid is arranged substantially along a plane defined by the edge structure, and wherein at least another portion of the grid is arranged out of the plane defined by the edge structure.

5. The floral design device of claim 1, wherein at least a portion of the grid is coupled to at least a portion of the edge structure.

6. The floral design device of claim 5, wherein the at least a portion of the grid is removably coupled to the at least a portion of the edge structure.

7. The floral design device of claim 1, wherein the edge structure is formed of one piece.

8. The floral design device of claim 1, wherein the one or more pieces of the edge structure includes at least two pieces, the at least two pieces including: at least one edge piece, and at least one cross piece coupled to the at least one edge piece.

9. The floral design device of claim 8, wherein the at least one cross piece is removably coupled to the at least one edge piece.

10. The floral design device of claim 1 further comprising at least one extension piece coupled to the edge structure, and configured to facilitate binding at least a portion of the edge structure to another object.

11. The floral design device of claim 1, further comprising means for binding at least a portion of the grid to another object.

12. The floral design device of claim 1, further comprising means for binding at least a portion of the edge structure to another object.

13. The floral design device of claim 1, wherein the perimeter of the one or more pieces of the edge structure defines a shape of the floral design device.

14. The floral design device of claim 13, wherein the shape is a polygon, pie shaped, at least partially circularly shaped, or at least partially ovoid shaped.

15. The floral design device of claim 13, wherein the shape has at least one partially arcuate side.

16. A floral design system comprising a plurality of instances of the floral design device of claim 1 coupled or bound together.

17. The floral design system of claim 16, wherein two or more of the plurality of instances of the floral design device are coupled together between a portion of the edge structure of a first floral design device and a portion of the edge structure of at least a second floral design device.

18. A method of manufacturing a floral design device, the method comprising:
forming or providing an edge structure as one or more pieces;
forming or providing a grid having a plurality of grid openings; and
placing the grid at least in part within a planar region defined by a perimeter of the one or more pieces of the edge structure.

19. The method of claim 18, wherein placing the grid comprises arranging the grid substantially along a plane defined by the edge structure.

20. The method of claim 18, wherein placing the grid comprises:
arranging at least a portion of the grid substantially along a plane defined by the edge structure; and
arranging at least another portion of the grid out of the plane defined by the edge structure.
